(19) United States
(12) Patent Application Publication
(10) Pub. No.: US 2014/0344005 A1
(43) Pub. Date: Nov. 20, 2014

(54) SYSTEM AND METHOD FOR PROVIDING A DOCUMENTARY AUDIT TRAIL IN COMPLYING WITH GOVERNMENT REGULATIONS

(71) Applicant: KPMG LLP, New York, NY (US)

(72) Inventor: Prabhakar Jayade, Plainsboro, NJ (US)

(73) Assignee: KPMG LLP, New York, NY (US)

(21) Appl. No.: 14/243,742

(22) Filed: Apr. 2, 2014

Related U.S. Application Data
(60) Provisional application No. 61/807,384, filed on Apr. 2, 2013.

(51) Int. Cl. G06Q 30/00; G06Q 10/06

(52) U.S. Cl. CPC G06Q 30/018; G06Q 10/06316
USPC 705/7.26

(57) ABSTRACT

A system and method of establishing a documentary audit trail for a government regulatory compliance review may include accessing a set of assertions derived from government regulations. Subsets of the assertions may be associated with ordered steps in a workflow. The subsets of the assertions may be applied to business data derived from at least one document as ordered by the workflow. In response to applying the subsets of assertions to the business data, the steps of the workflow may be recorded in association with the respective subsets of the assertions. A report showing which of the assertions were applied to the business data at each of the ordered steps of the workflow may be generated, thereby creating an audit trail as to which government regulations were applied to business data during the regulatory compliance review.

### RELATED APPLICATIONS

This application claims priority to co-pending U.S. Provisional Application Ser. No. 61/807,384 filed Apr. 2, 2013 and entitled “System and Method for Client Onboarding”; the contents of which are hereby incorporated by reference in their entirety.

### BACKGROUND

Businesses are driven by rules. These rules are developed over time for efficiency purposes, risk reduction purposes, practical business execution purposes, and, often in the case of government regulated industries, regulation compliance purposes. Government regulations often contains thousands of regulations to be followed by industries. As an example, the banking industry is highly regulated and thousands of banking regulations exist for many, many reasons. As a regulatory example, to combat money laundering and terrorism, one recent significant government regulation is “Know Your Customer” (KYC) that requires a bank that is onboarding a potential customer to perform due diligence and examine relevant information of the potential customer prior to onboarding or otherwise working on behalf of the customer. For potential customers who are individuals, the compliance review process to comply with KYC regulations is relatively straight forward. However, for corporate customers, the process is extensive, time consuming, challenging, and expensive - even with using today's most advanced technical tools. The cost for each Tier-I bank just to comply with the KYC regulations may be upwards of $100 million per year. Other government regulations include Foreign Account Tax Compliant Act (FATCA), Dodd-Frank, Patriot Act, and so on. Each of these and the many other government regulations require strict compliance to avoid penalties by government regulators.

In complying with government regulations and business rules for various business processes, including client onboarding, there have historically been two methods used, including (i) a manual compliance process and (ii) a computer workflow compliance process. The manual compliance process typically is performed by one or more compliance reviews (i) having a paper or computer display listing of current business rules and government regulations with which to comply, and (ii) manually reviewing customer documents to ensure compliance with each of the company rules and government regulations. As well understood in the art, this manual compliance process is very time-consuming, costly, and inefficient. The computer workflow compliance process offers slightly more efficiency than the manual compliance process by uploading documents (e.g., customer operations documents) to an electronic document review system that typically (i) provides an electronic list of company rules and government regulations, and (ii) enables a reviewer to review the uploaded electronic documents as guided by the workflow process to determine compliance of the company rules and government regulations. While the workflow and other aspects of the computer workflow compliance process may be automated, the actual review of the documents that are subject to compliance is a manual process that requires a reviewer to manually review each document, albeit on a computer screen, and determine whether the document complies with the company rules and government regulations. Even with the computerized workflow compliance processes, Tier-I banks often have hundreds or thousands of compliance personnel to handle KYC compliance reviews, among other compliance issues.

Despite client onboarding processes having been improved through use of computerized workflow, as a result of the complexity of government regulations and constant changes being made thereto, the ability for compliance reviewers to manage the review process and accurately document the review to satisfy government regulators is an overwhelming task. That is, the ability to document the review process accurately and sufficiently enough to be able to show full compliance of government regulations for every customer that has been onboarded or otherwise has routinely been found to be insufficient for government regulators. Moreover, the ability to retroactively determine which specific regulations and interpretations were applied to which business data is simply not possible today. Despite the fact that fines of $700 million and higher have been levied against Tier-I banks by government regulators, provable audit trails for KYC regulations are still not properly maintained, which means that high-risk remains for government regulated industry participants, Tier-I and lower.

### SUMMARY

To eliminate the problems and risks associated with audits of compliance review processes, the principles of the present invention provides for automatically generating compliance audit records. The compliance audit records may be generated in response to computer-executable assertions being applied to business data. The assertions may be in a resource description format (e.g., RDF triple), and be applied to business data, which may be stored in a no SQL format. The audit records may include tracking which assertions or groups of assertions in steps of a workflow were applied to which business data and audit results of each assertion. Other data of the audit records may include a timestamp, name or identifier of an operator who initiated the compliance review, version identifier of the assertions, revision of government regulations from which the assertions were derived, and so forth.

One embodiment of a method of establishing a documentary audit trail for a government regulatory compliance review may include accessing a set of assertions derived from government regulations, where each of the assertions may be computer-executable and have a unique identifier associated therewith. Subsets of the assertions may be associated with ordered steps in a workflow, where each of the steps in the workflow have a unique identifier associated therewith. The subsets of the assertions may be applied to business data derived from at least one document as ordered by the workflow. In response to applying the subsets of assertions to the business data, unique identifiers of the steps of the workflow may be recorded in association with the unique identifiers of the respective subsets of the assertions. A report showing which of the assertions were applied to the business data at each of the ordered steps of the workflow may be generated, thereby creating an audit trail as to which government regulations were applied to business data during the regulatory compliance review.

One embodiment of a system for establishing a documentary audit trail for a government regulatory compliance review may include a storage unit and a processing unit in communication with the storage unit. The processing unit may be configured to access, from a data repository being stored on the storage unit, a set of assertions derived from government regulations, each of the assertions being computer-executable and having a unique identifier associated therewith. Subsets of the assertions may be associated with ordered steps in a workflow, where each of the steps in the workflow have a unique identifier associated therewith. The subsets of the assertions may be applied to business data derived from at least one document as ordered by the workflow. In response to applying the subsets of assertions to the business data, unique identifiers of the steps of the workflow may be recorded on the storage unit in association with the unique identifiers of the respective subsets of the assertions. A report showing which of the assertions were applied to the business data at each of the ordered steps of the workflow may be generated, thereby creating an audit trail as to which government regulations were applied to business data during the regulatory compliance review.

### BRIEF DESCRIPTION

A more complete understanding of the method and apparatus of the present invention may be obtained by reference to the following Detailed Description when taken in conjunction with the accompanying Drawings wherein:

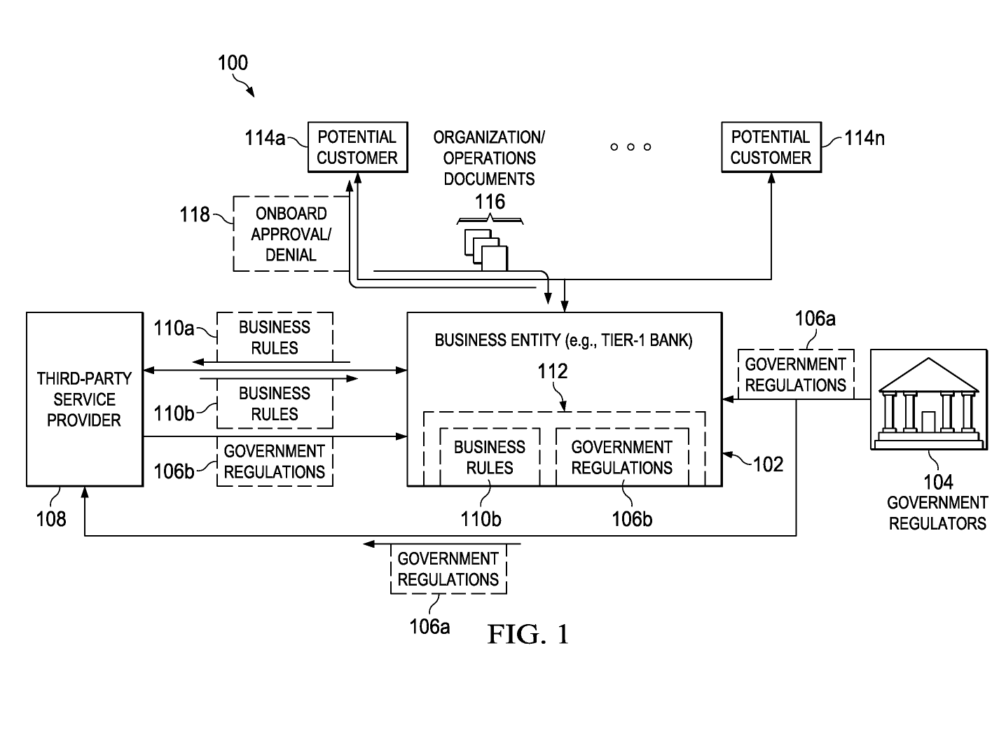

FIG. 1 is an illustration of an illustrative regulated business environment in which a business entity, such as a bank, operates under government regulations and performs Know Your Customer onboarding compliance reviews;

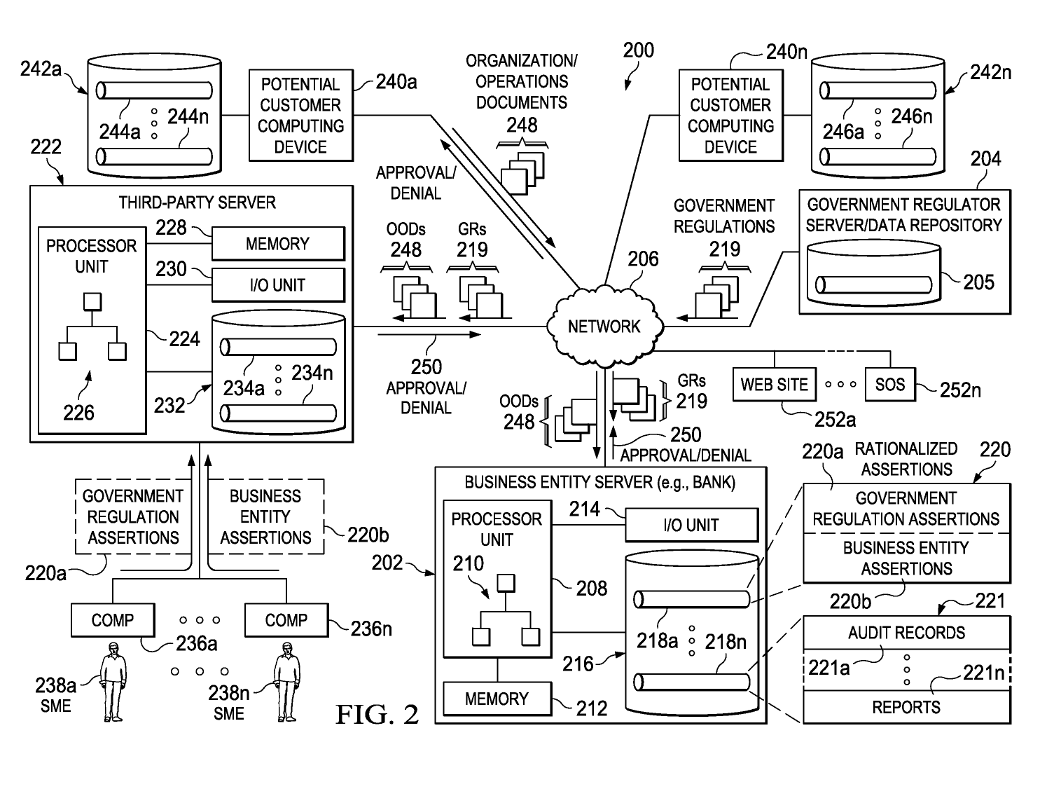

FIG. 2 is an illustration of an illustrative network environment of the business entity in supporting customer onboarding in the government regulated environment of FIG. 1 in accordance with the principles of the present invention;

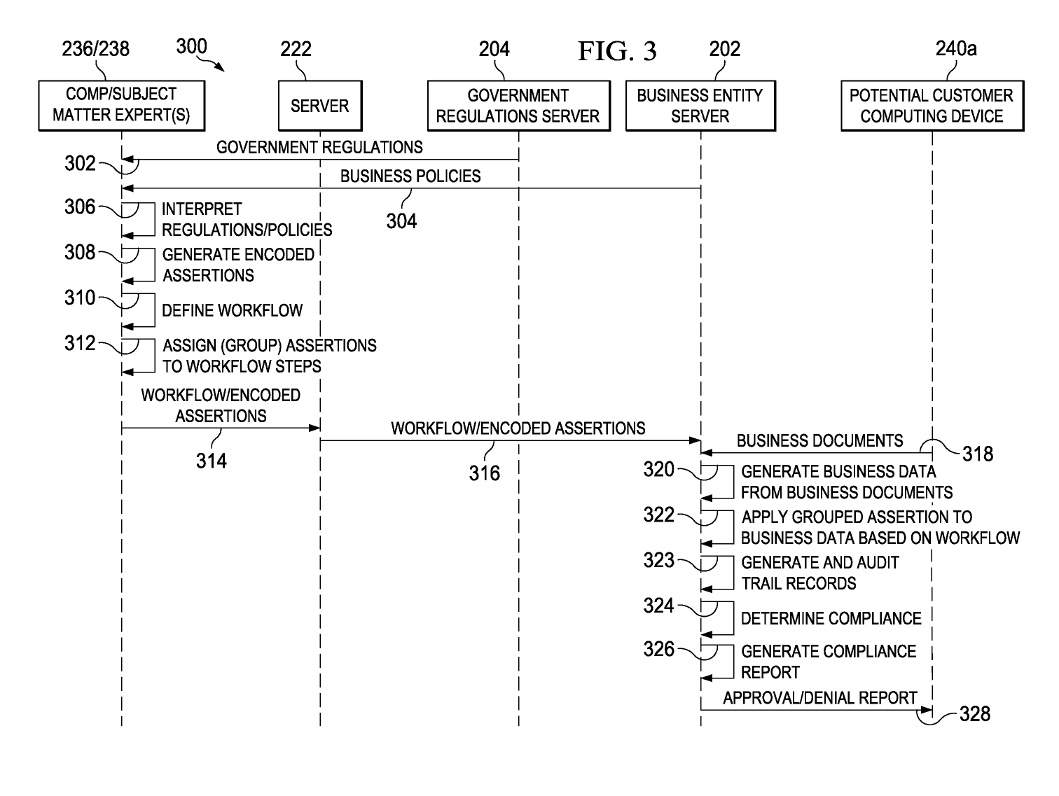

FIG. 3 is an interaction diagram of an illustrative process for a business entity to perform customer onboarding utilizing the principles of the present invention;

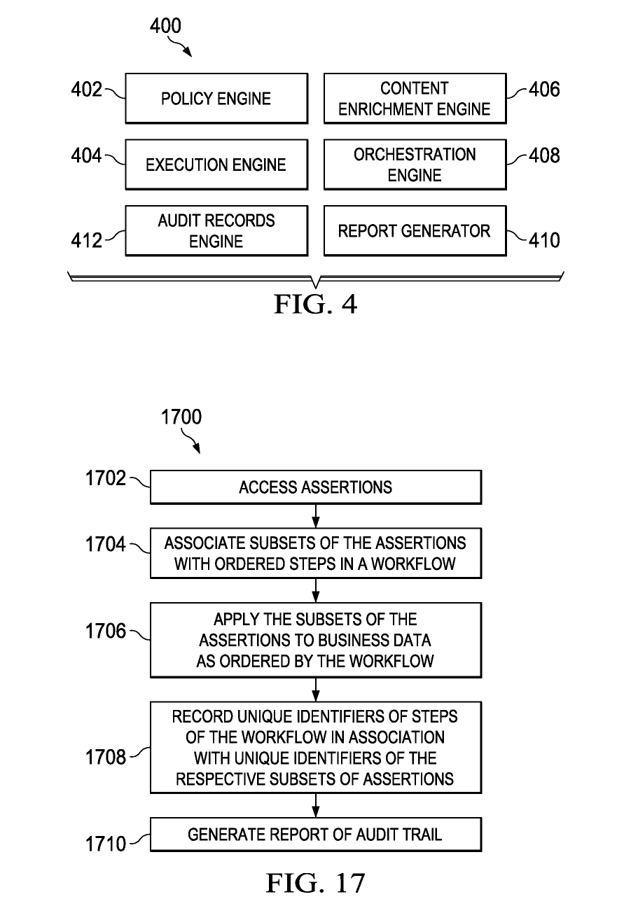

FIG. 4 is a block diagram of a illustrative modules that may be executed by a computing system for performing compliance of business data in accordance with the principles of the present invention;

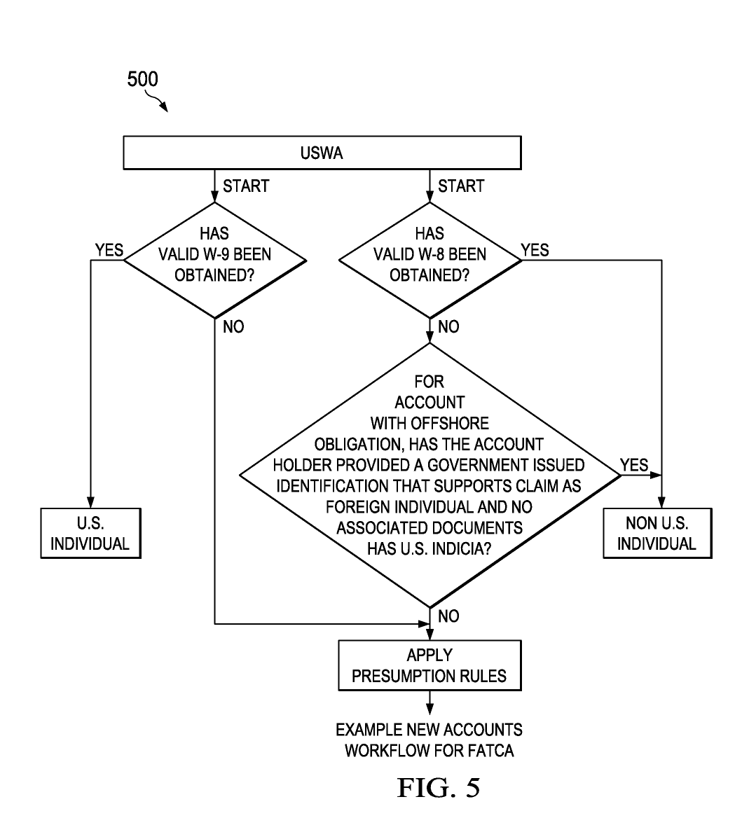

FIG. 5 is a flow diagram of an illustrative workflow for opening new accounts to comply with the Foreign Accounts Tax Compliance Act (FATCA) for customer onboarding as defined in the policy engine workflow of FIG. 4;

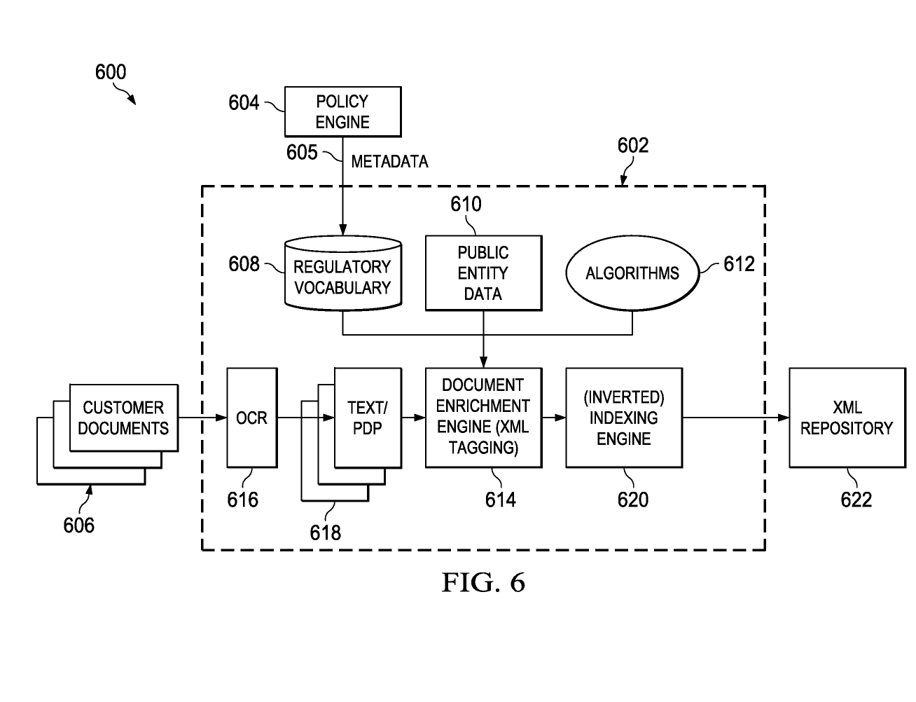

FIG. 6 is a block diagram of an illustrative content enrichment framework;

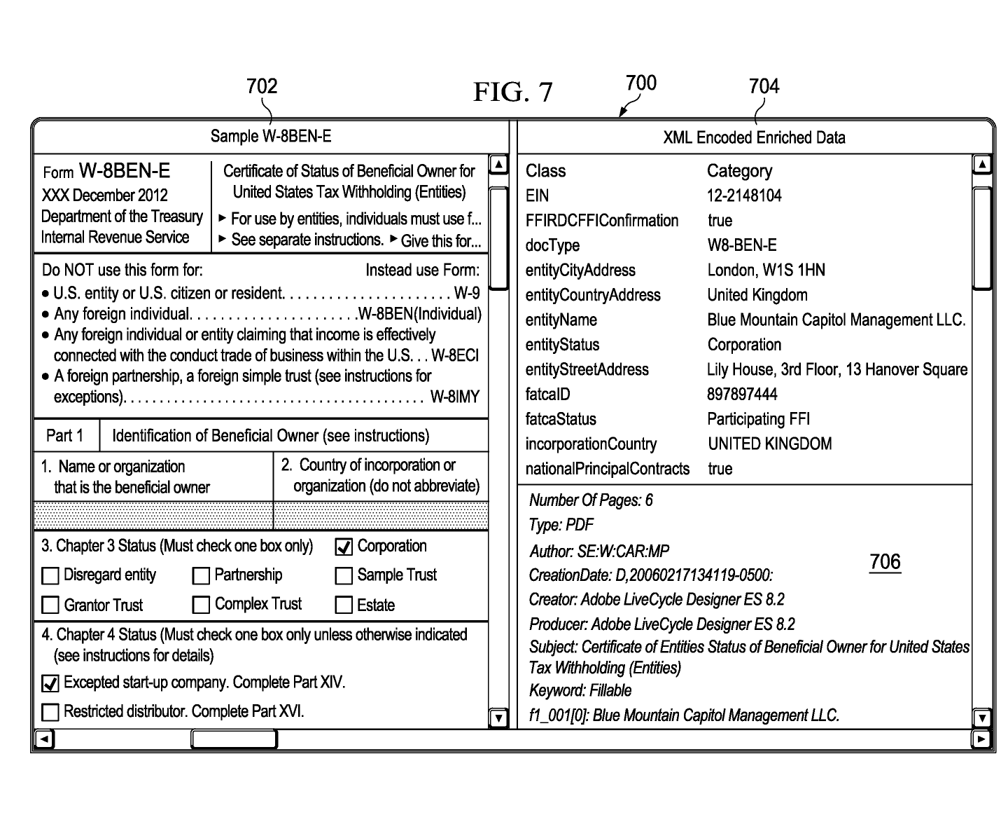

FIG. 7 is an illustration of an illustrative business document and business data derived from the business document;

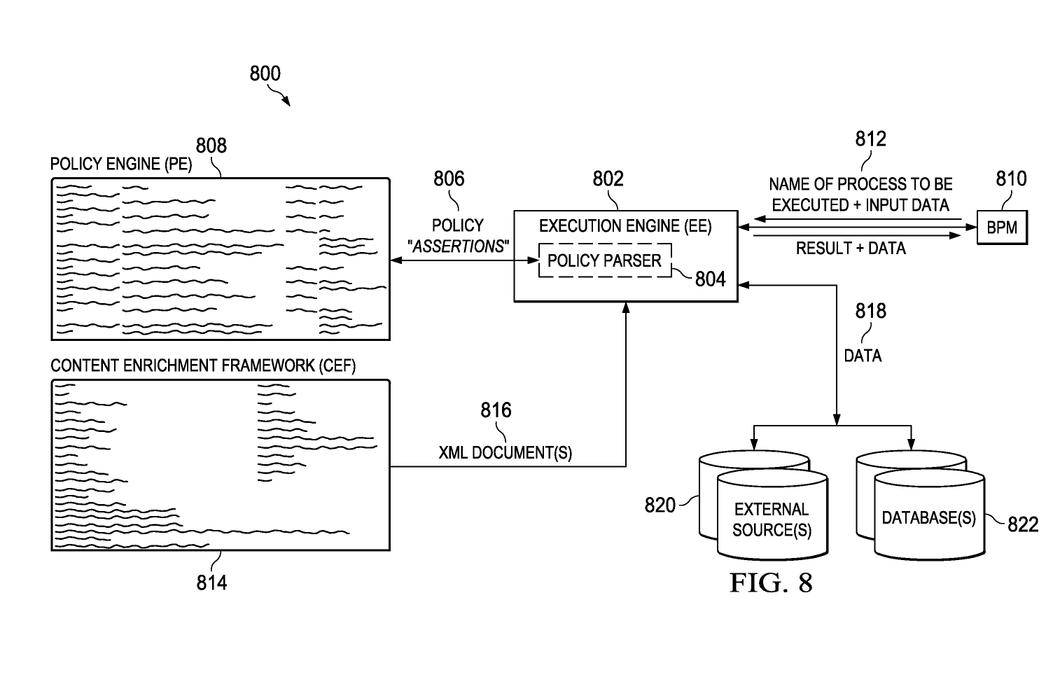

FIG. 8 is an illustration of an illustrative execution engine environment;

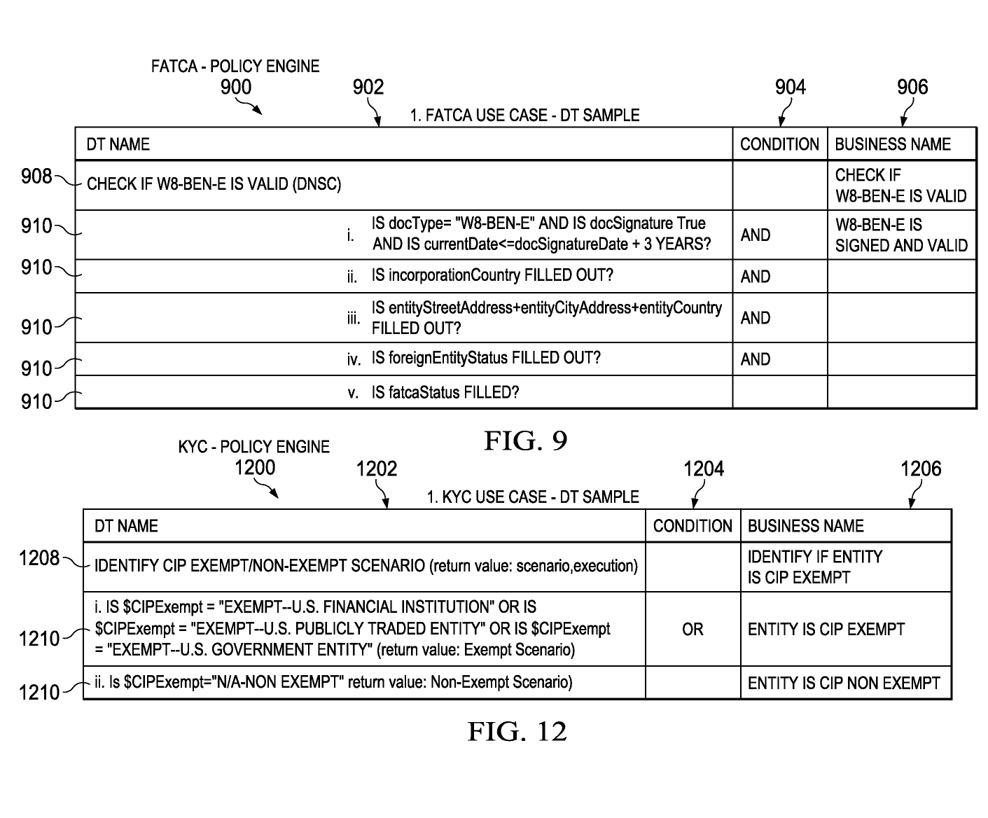

FIG. 9 is a chart showing an illustrative decision table inclusive of assertions for a FATCA use case;

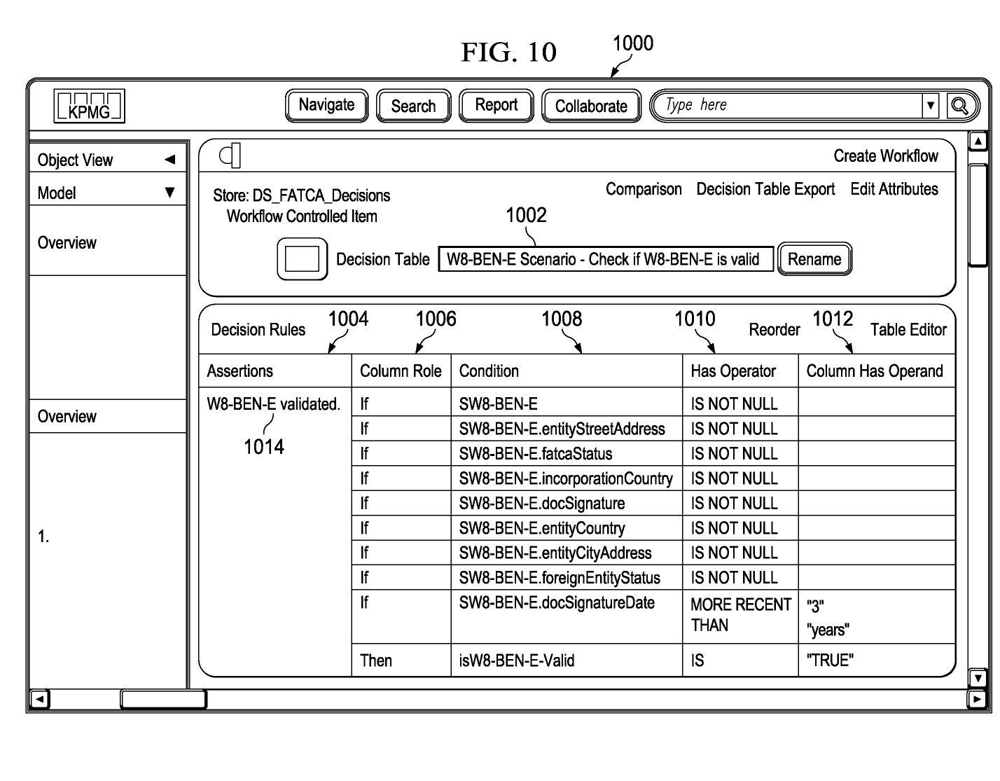

FIG. 10 is a screenshot of an illustrative decision model editor that may be used in generating a decision table, in this case a FATCA compliance review;

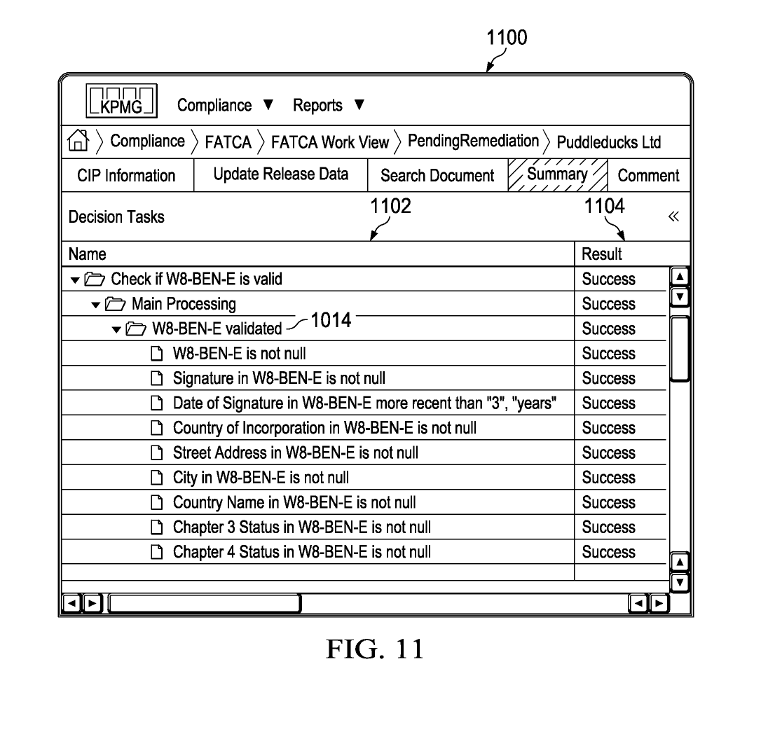

FIG. 11 is a screenshot of an illustrative audit trail resulting from applying decision tables, including that defined in FIG. 10, to business data;

FIG. 12 is a chart showing an illustrative decision table inclusive of assertions for a KYC use case;

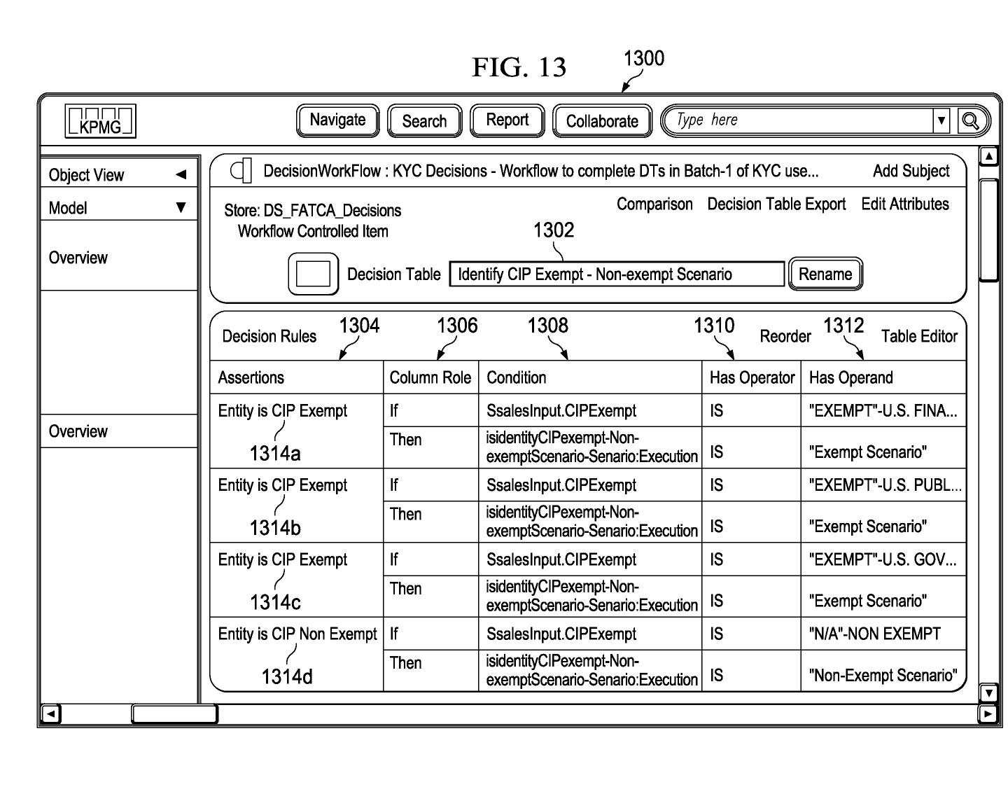

FIG. 13 is a screenshot of an illustrative decision model editor that may be used in generating a decision table, in this case a KYC compliance review;

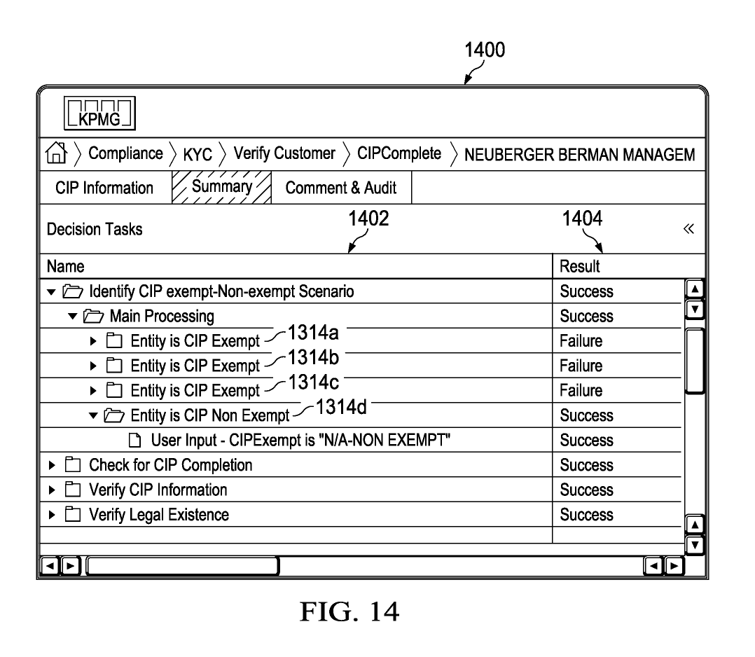

FIG. 14 is a screenshot of an illustrative audit trail resulting from applying decision tables, including those defined in FIG. 13, to business data;

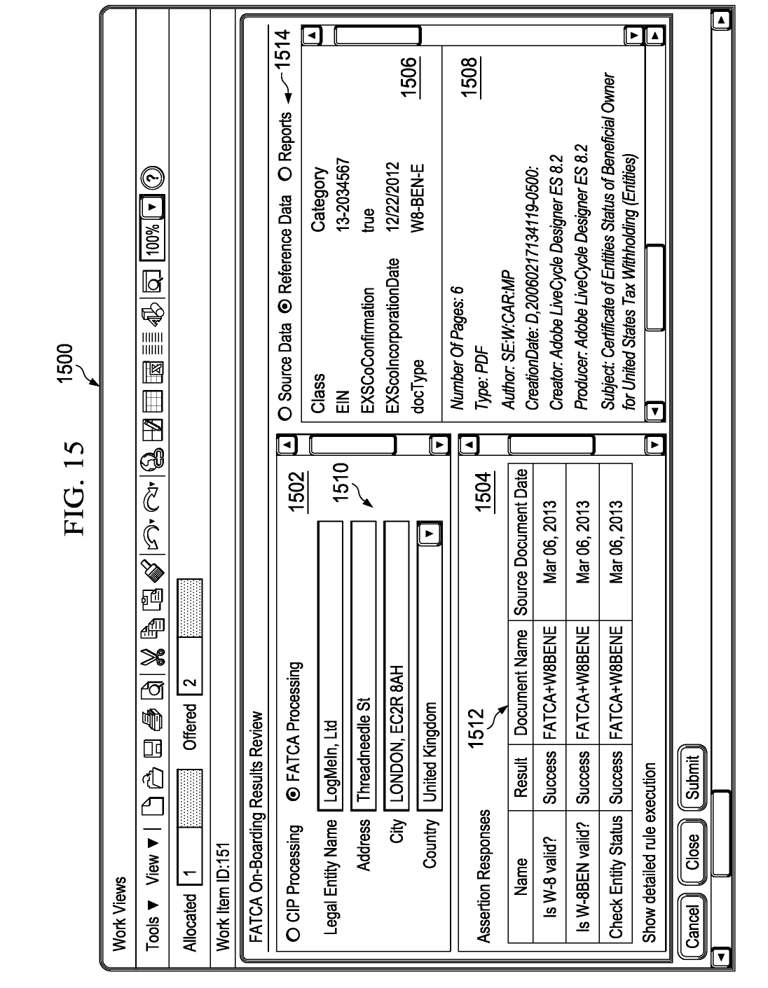

FIG. 15 a screenshot of an illustrative user interface on which a user may perform and/or review extracted reference data of a compliance review, such as a customer onboarding compliance process;

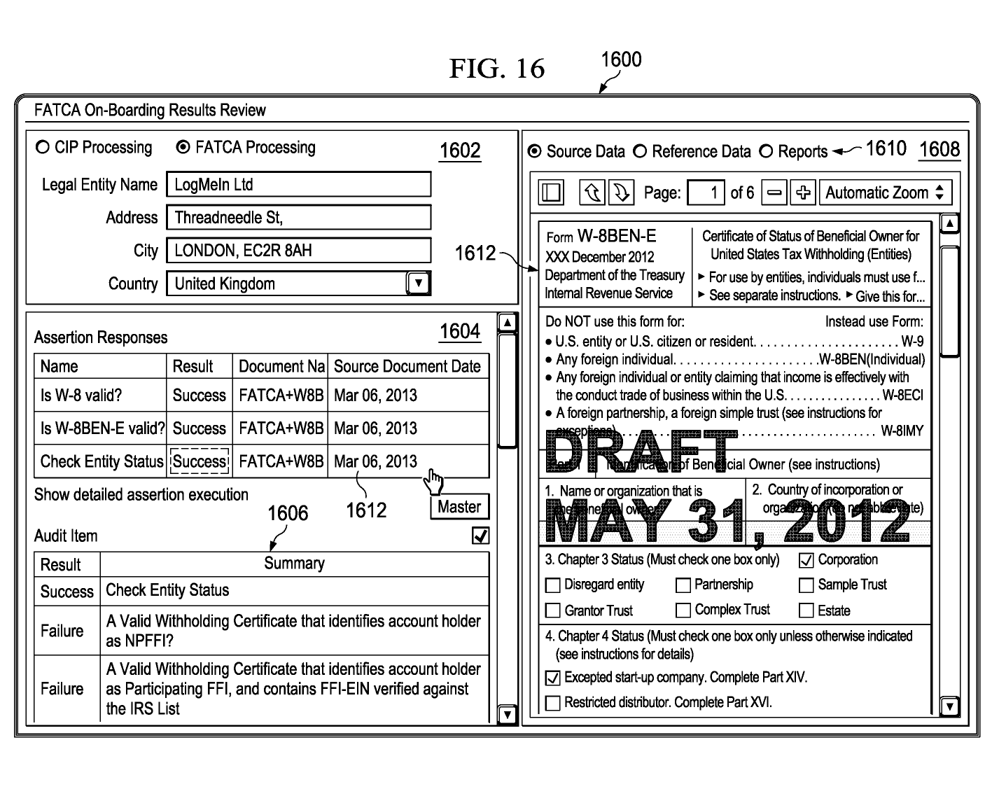

FIG. 16 is a screenshot of an illustrative user interface that provides a user with an audit trail of a compliance review of business data utilizing the principles of the present invention; and

FIG. 17 is a flow diagram of an illustrative process for establishing an audit trail for a government regulation compliance review.

### DETAILED DESCRIPTION OF THE DRAWINGS

Most business strategy and operations, especially regulatory and compliance operations, can be modeled into a unique repeatable pattern, sometimes called business-behavior pattern. Business-behavior pattern can be solved by a combination of (i) the ability to process financial data as unstructured data and (ii) the ability to use business metadata modeling standards and tools to model government regulations, business rules, business risk, business operations, and regulatory policies.

With regard to business-behavior patterns, policy defines the “business,” and business transaction data represents “behavior.” The policies, which may include government regulations, business rules, and so on, are applied to the business data. Business data that does not conform to the policies represent “outlier” behavior. Outlier behavior is deemed “non-compliant” if the policies are regulatory, where the outlier behavior is “risk” if the policies are business (e.g., credit, market, operation) policies. The outlier behavior is “opportunity” if the policies are business development, and so on. Examples of long-standing industry issues that fit the business-behavior pattern include customer onboarding, reconciliation, legal entity rationalization, Basil 2.5/III, liquidity risk, compliance, and so on.

The most scrutinized aspect of any business, and more so of the financial services business, is the adherence of the business to government regulatory policies. The business-behavior pattern solves for the business adherence to government regulatory policy variables, among others.

Business behavior typically begins with vision and translates to specific goals, which ultimately translate to business policies. Business policies serve as guidelines for designing an organization and operations thereof, and ultimately become a tool for business governance to ensure ongoing business adheres to current business policies. In accordance with the principles of the present invention, three design elements may be used to define a pattern design, and these design elements include (i) decision model, (ii) semantic model, and (iii) governance model.

Decision models may be defined for computer execution using resource description format (RDF), which is an object management group/worldwide web consortium (OMG/W3C) standard that describes each policy-condition as an “assertion” that evaluates to a Boolean when tested against business data. The business models may be based on decision modeling notation (DMN), which is an emerging standard. Decision models may be made up of one or many decision-tables joined by association or hierarchy using ontology modeling notation. The ontology model notation provides for the following attributes for the pattern to be complete and available for computer-execution: assertions defined in RDF triples (subject-predicate-object), operators for the predicates, and Boolean to compound the assertions. The assertions defined in RDF triples may define a decision-table.

The semantic model provides a vocabulary that describes a domain to which the policies apply, namely the business (e.g., banking business). The semantic model also encodes the policies as assertions, and describes business documents that include business data in all forms, namely (i) unstructured (paper-based contracts, email, social media, web page, etc.), (ii) semi-structured (electronic forms), and (iii) structured (enterprise reference, position, and transaction data). Among other things, the semantic model includes very specific definitions of identity, such as fingerprinting, necessary and sufficient conditions, including completeness, and so on. In broader terms, the semantic model defines the data quality rules from a business perspective.

The semantic model may incorporate a content enrichment framework (FIG. 6) that creates tags, such as XML tags, to unstructured data by using the vocabulary of the semantic model to create the enrichment tags. These tags may be indexed by an execution engine so that the business data can be searched in an unstructured search format (e.g., keyword search tool for analysts/case workers to research open cases). In one embodiment, the search may incorporate a “fuzzy search” feature that uses the semantic model to render the fuzzy search when identifying “values” between the enrichment tags. As understood in the art, a fuzzy search allows for closeness of a match to be measured in terms of a number of “primitive operations” necessary to convert a search string into an exact match. The number is known as the “edit distance” between the search string and the pattern, and typically look for words that have insertions (e.g., cot→coat), deletions (e.g., coat→cot), substitutions (e.g., coat→cost), transpositions (e.g., cost→cots), and abbreviations (e.g., Ltd.→Limited). The output of these rules may be vetted against people, places, and things database that the content enrichment framework utilizes to create an abbreviation or other dictionary.

The semantic model may incorporate a governance model that provides core elements of governance that are defined as a part of this pattern and may include: (i) organization and roles and (ii) business-process steps. The governance model may form a matrix with business-process along the X-axis and organizations along the Y-axis. In each of the matrix “cells,” a customer onboarding business process responsibility assignment matrix (e.g., RACI) is allocated. Thus, any outlier behavior indicated will be in a cell, and escalation rules can be applied based on which of RACI governance roles (i.e., responsible (R), accountable (A), consulted (C), and informed (I)) is identified within the cell. TABLE 1 below is illustrative of a customer onboarding process:

TABLE 1

| | Defining | | Contractual | | | Organization |
|---|---|---|---|---|---|---|
| Customer | Relationship | Profiling | Documents | Approval | Activation | Escalation |
| Sales | R, A | C | C | I | A | Owner |
| | | | | | | Steward |
| Credit | C | R | R | R | I | Owner |
| | | | | | | Steward |
| Legal | C | R | A | R | I | Owner |
| | | | | | | Steward |
| Compliance | I | A | C | R, A | I | Owner |
| | | | | | | Steward |
| (Onboarding) | I | I | I | I | R | Owner |
| Operations | | | | | | Steward |
| Process | Owner | Owner | Owner | Owner | Owner | Owner |
| Escalation | Steward | Steward | Steward | Steward | Steward | Steward |

With regard to FIG. 1, an illustration of an illustrative regulated business environment 100 in which a business entity, such as a bank, operates under government regulations and performs customer onboarding reviews is shown. The regulated business environment 100 is shown to include a business entity 102, such as a Tier-1 bank, that is regulated by government regulators 104. As understood in the art, government regulators 104 define government regulations 106a under which industries operate. The government regulations 106a may be defined in a number of ways, including laws, rules, limits, or any other format used to specify duties, rights, constraints, limits, responsibilities, and so forth as defined by the government. As shown, the government regulations 106a may be distributed to or otherwise imposed on the business entity 102, which, of course, is forced to comply so as to avoid violations that often come with steep fines on violators. The government regulations 106a are generally published by the government regulators 104 on both paper and in an electronic format. Although not shown, it should be understood that industry leadership groups, such as standards organizations (e.g., International Organization for Standardization (ISO)), that are not governmental bodies may also define rules, parameters, or other criteria under which industry participants may choose to operate so as to be compliant with other industry leaders.

In addition to the business entity 102, the government regulations 106a may be utilized by a third-party service provider 108, such as a consulting firm (e.g., KPMG), that may specialize in interpreting the government regulations. As understood in the art, the interpretation of government regulations are performed by subject matter experts (SMEs). From the interpretation, the third-party service provider 108 may generate government regulations 106b that are in a different format, such as a computer-executable format, that can be used by the business entity 102 for ensuring that the government regulations 106b are being followed while conducting business (e.g., customer onboarding by a bank). It should be understood that the business entity 102 may alternatively perform the interpretation of the government regulations 106a. However, in most heavily regulated industries, significant reliance on third-party service providers who specialize in interpreting regulations and assist companies in complying with the government regulations 106a are utilized to reduce the risk of the business entity 102 violating the government regulations 106a.

In addition, the business entity 102 may provide the third-party service provider 108 with business rules 110a with which the business entity 102 follows, and the third-party service provider 108 may interpret and generate business rules 110b in a format that is in the same or similar format as that of the government regulations 106b. It should be understood that the business entity 102 may alternatively perform the interpretation of the business rules 110a. The business entity 102 may utilize a rationalized set of assertions 112 composed of the government regulations 106b and business rules 110b for customer onboarding or other business or government regulation compliance requirements.

More particularly, the business entity 102 may operate to service potential customers 114 by collecting organizational (e.g., articles of incorporation) and/or operational documents (e.g., trade settlement documents) 116 from a potential customer. Utilizing the rationalized set of assertions 112, or either of the government regulations 106b or business rules 110b, customer onboarding or compliance review may be performed in an semi-automated or automated manner. Business data may be automatically generated and/or collected from the documents 116, depending on the format of the documents 116, for use in applying the set of assertions 112, as further described hereinbelow. Resulting from applying the set of assertions 112 to the business data contained in the documents 116, an onboarding approval or rejection report 118 may be generated and communicated to the potential customer 114a. Alternatively, rather than sending a complete report, an abbreviated or summary report or notice may be generated and provided to the potential customer 114a.

With regard to FIG. 2, an illustration of an illustrative network environment 200 of the business entity that supports customer onboarding in the government regulated environment of FIG. 1 in accordance with the principles of the present invention is shown. The network environment 200 includes a business entity server 202 configured to apply assertions to business data of potential customers in performing customer onboarding compliance reviews. The business entity server 202 may be in communication with a government regulator server 204 that includes a data storage unit 205 configured to store a data repository. The storage unit 205 may be configured to store information of the government regulator, including government regulations. The business entity server 202 may communicate with the government regulator server 204 via a communications network 206. It should be understood that the server 204 and/or storage unit 205 may be managed by any other entity other than the government regulator or that the government regulators may be available from any other source and in any format.

The business entity server 202 may include a processing unit 208 formed of one or more computer processors that execute software 210. The software 210 may be configured to cause the processing unit 208 to perform a variety of functions, such as customer onboarding compliance functions, in accordance with the principles of the present invention. The processing unit 208 may be in communication with memory 212 operable to store data and software, input/output unit 214 configured to communicate data over the communications network 206 using any number of communications protocols, as understood in the art, and storage unit 216. The storage unit 216 may be configured to store data repositories 218a-218n (collectively 218). In one embodiment, the business entity server 202 may access government regulations 219, which may be stored in a variety of formats, including text, HTML, PDF, XML, of otherwise. Within the data repositories 218, rationalized assertions 220, which may include government regulation assertions 220a and/or business entity assertions 220b. As will be described further herein, the government regulation assertions 220a and business entity assertions 220b are in a computer-executable format that allows for the processing unit 208 to perform customer onboarding compliance functions, among others. The data repositories 218 may also be configured to store business compliance data 221, including audit records 221a, compliance reports 221n, and any other compliance results data.

In one embodiment, a third-party server 222 may be configured to perform the same or similar functions as the business entity server 202 to enable a business entity to outsource various compliance functions, such as customer onboarding, to the third-party, such as a consulting firm. The third-party 222 server may include a processing unit 224 composed of one or more computer processors configured to execute software 226. The processing unit 224 may be in communication with memory 228, input/output unit 230, and storage unit 232. The storage unit 232 may be configured to store one or more data repository 234a-234n (collectively 234). The data repositories may store government regulation assertions (not shown) in a computer-executable format, business entity assertions (not shown) in a computer-executable format, and/or any other data for use in conducting business compliance or any other functions.

As shown, computers 236a-236n (collectively 236) may be in communication with third-party server 222, and be used by subject matter experts 238a-238n (collectively 238). The subject matter experts 238 may analyze, interpret, and encode the government regulations 219 using an enriched vocabulary (not shown). The enriched vocabulary may be standardized or proprietary as developed by the third-party and be specific toward interpreting government regulations, such as those directed to customer onboarding. The enriched vocabulary may be used as part of creating a semantic web (SW) standard model, such as RDF or RDF triple. As shown, the subject matter experts 238 may create government regulation assertions 220a and business entity assertions 220b by parsing the government regulations and business rules or rules derived therefrom manually, semi-automatically, or automatically by the subject matter experts 238. The government regulation assertions 220a and business entity assertions 220b may be stored in the data repositories 234 for use by the third-party server (e.g., performing a compliance review) and/or communicating the government regulation assertions 220a and business entity assertions 220b to the business entity server 202 for storage in the data repository 218a. Of course, because every business entity has unique business rules, the business entity assertions 220b are specifically associated with the associated business entity.

As further shown in FIG. 2, potential customer computing devices 240a-240n (collectively 240) may be in communication with the business entity server 202. In this case, the potential customers are shown prior to being actual customers of the business entity and have to be processed through a customer onboarding compliance review process. Once the potential customer is approved to be a customer after passing the customer onboarding compliance review process, the computing devices are deemed customer computing devices. Each of the potential customer computing devices 240 have associated storage units 242a-242n (collectively 242) respectively inclusive of data repositories 244a-244n (collectively 244) and 246a-246n (collectively 246). The data repositories 244 and 246 may store corporate organization documents (e.g., management or governance documents, such as quarterly corporate filings and tax form filings) and operations documents (e.g., business transaction documents, such as stock trades or sales records).

In operation, the potential customer computing device 240a may communicate organization/operations documents (OODs) 248 to the business entity server 202 and/or third-party server 222 for processing thereat. It should be understood that the principles of the present invention may operate by the business entity imaging (e.g., scanning) paper documents as opposed to communicating them over the network 206. The business data contained in the documents 248 may be unstructured (e.g., text documents, reports, etc.), semi-structured (e.g., emails, websites, business forms), or structured (e.g., structured databases, XML feeds) and be inclusive of actual data and/or associated metadata. In the case of documents being unstructured, a conventional OCR process may be utilized to “read” data, and tags may be applied to the data using a vocabulary defined by the business entity and/or third-party so that an automated compliance review process may thereafter be conducted. The rationalized assertions 220 may be applied to the business data of the documents 248 by the business entity server 202 and/or third-party server 222 for performing a customer onboarding compliance review, as further described herein. In response, an approval/denial report 250, which may be a full compliance report, summary report, or simply an approval or denial notice, may be communicated to the potential customer computing device 240a. It should also be understood that the business entity server 202 may send an outsource request (not shown) to the third-party server 222 to perform the customer onboarding compliance review and the approval/denial report 250 may be communicated to the business entity server 202 for storage and communication to the potential customer computing device 240a.

After a customer is onboarded, the principles of the present invention may provide for monitoring public documents of the customer so as to perform post-onboarding monitoring of the customer. In one embodiment, websites and publicly available databases 252a-252n, such as government websites (e.g., secretary of state offices), public reporting document websites (e.g., quarterly and annual report websites), news websites, and so forth may be monitored and documents associated with the customer may be collected to form new business data. The new business data from the documents may be collected and added to the previous business data. The assertions may be applied to the new business data being fed back, thereby ensuring that the customer continues to remain compliant with the customer onboarding compliance requirements along with any other compliance requirements of the business entity.

With regard to FIG. 3, an interaction diagram of an illustrative process 300 for a business entity to perform customer onboarding utilizing the principles of the present invention is shown. The process 300 is shown to include a number of components as part of the process, including computer(s)/subject matter expert(s) 238, server 222, government regulations server 204, business entity server 202, and potential customer computing device 240a. The process 300 may start at step 302, where government regulations may be communicated to the server 222 and computer(s)/subject matter expert(s) 236. The business entity server 202 may communicate business policies at step 304 to the server 222 and computer(s)/subject matter expert(s) 236/238. At step 306, the government regulations and business policies may be interpreted by the computer(s)/subject matter expert(s), and encoded assertions may be generated thereby at step 308. In addition, unique identifiers may be assigned to each of the encoded assertions. The unique identifiers may be numeric (e.g., generated in an ordered sequence or otherwise, alphanumeric (e.g., name of assertion), or otherwise (e.g., memory or database location identifier)). The unique identifiers may be used for managing the assertions and for use in generating an audit trail.

At step 310, a workflow for performing a customer onboarding process (or any other KYC regulated process, for example) may be established manually (e.g., by a subject matter expert), semi-automatically (e.g., heuristic guidance for a user to accept or modify), or automatically (e.g., heuristic guidance, using neural networks, etc.). Each step of the workflow may be assigned a unique identifier. At step 312, the encoded assertions may be assigned to or grouped into the steps of the workflow. The encoded assertions may be grouped in a logical manner to perform functions of the steps of the workflow and the unique identifiers of the encoded assertions may be associated with the step(s) with which each of the encoded assertions are assigned, as further described herein. Moreover, in assigning the grouped encoded assertions to the steps of the workflow, the unique identifiers of each of the encoded assertions may be assigned to each of the unique identifiers of the steps of the workflow. For example, if encoded assertions 1-10 exist and there are four steps A-D in the workflow, workflow step A may be assigned encoded assertions 1, 2, 3; workflow step B may be assigned encoded assertions 4, 5; workflow step C may be assigned encoded assertions 6, 7; and workflow step D may be assigned encoded assertions 8, 9, 10. The workflow steps are meant to perform certain workflow functions, so the encoded assertions assigned to each of the workflow steps are to be logically related to the workflow step into which it is applied. It should be understood that an encoded assertion may be grouped with multiple, different groups and assigned to more than one workflow step.

The grouped encoded assertions may be communicated to the server 222 at step 312. It should be understood that the computer(s) 236 being used by the subject matter expert(s) 238 may cause the operations of steps 306-312 to be performed directly by the server 222, thereby eliminating the need to communicate the workflow and encoded assertions to be communicated at step 314.

At step 316, the server 222 may communicate the workflow and grouped encoded assertions to the business entity server 202 for the workflow to be performed by the business entity server 202. The server 222, which may be that of a third-party, may additionally or alternatively execute the workflow process on business data that may be provided to the server 222 or accessed at the business entity server 202 or elsewhere. At step 318, the potential customer computing device 240a may communicate business documents of the customer to the business entity server 202. It should be understood that any technique and communications protocol may be utilized in communicating the business documents from the computing device 240a to the business entity server 202.

At step 320, business data from the business documents may be generated. In generating the business data, a variety of parsing techniques may be utilized depending on the format of the business documents. That is, the business documents may be non-structured, semi-structured, or structured, as previously described, and different parsing techniques, as understood in the art, may be utilized to generate business data based on those business documents.

At step 322, the grouped encoded assertions may be applied to the business data based on the workflow steps using an orchestration engine, where the orchestration engine causes the workflow to automatically step through the steps of the workflow and apply each of the assertions associated at each respective step. The application of the grouped encoded assertions may be automatic or semi-automatic (e.g., steps manually selected and applied and results of each step displayed for a user to monitor).

At step 323, audit trail records may be generated. In generating the audit trail records, unique identifiers of steps of a workflow along with unique identifiers of assertions being applied to business data at each step of the workflow may be recorded. In that regard, the business data, metadata and/or tag(s) associated with the business data, results of executing or applying each of the assertions or a collective result of a group of assertions, name or identifier of an operator who initiated the compliance review, version identifier of the assertions, revision of government regulations from which the assertions were derived, and so forth may be associated or otherwise referenced with the steps of the workflow and assertions to complete the audit trail records. Although shown as being a distinct step, it should be understood that the process of generating audit trail records may be integrated into step 322 such that an audit trail record is generated in response to each assertion or group of assertions being applied to the business data.

At step 324, compliance of the government regulations and/or business policies may be determined. As each assertion applied to the business data produces a Boolean result, the determination of compliance may be a YES or a NO answer. Alternatively, the determination may be a percentage of YES and NO answers (e.g., 86% YES/NO). In one embodiment, the result of applying an assertion to the business data may also provide for an error code or reason for the compliance data not complying with the assertion. Such reasons may include “data not found,” “insufficient data,” “data does not match allowable parameters,” and several other possible reasons for non-compliance.

In addition to applying each of the assertions to the business data, an audit trail record may be created by the business entity server 202 recording unique identifiers associated with each of the workflow steps along with unique identifiers of each of the assertions that are applied to the business data. The audit trail records enable the business entity to instantly provide a record of actual government regulations that were applied to business data to business executives and/or government regulators. For example, using the previous example with four workflow steps, each of the assertions 1-10 that were applied to particular business data can be listed, timestamped as of the date and time of execution, identification of employee initiated the workflow, resulting compliance report, users who accessed the compliance report, and so on. In addition, the unique identifiers of the steps of the workflow and assertions may be presented in an audit trail report or simply used to manage associations of data (e.g., assertions and workflow steps) for display in the audit trail report. By being able to being able to provide exact audit trail records of the compliance efforts performed for complying with business rules and/or government regulations, the business entity can avoid potentially huge fines that are routinely levied against companies by government regulators as a result of not being able to produce verifiable audit records of compliance activities.

At step 326, a compliance report may be generated. The compliance report may include a listing of results of each assertion applied to the business data, a summary of each of the workflow steps, an overall summary as to percentage of passes/fails of each assertion and/or each workflow step, or a simple pass/fail of the compliance test defined by the workflow. At step 328, an approval/denial report may be communicated from the business entity server 202 to the potential customer computing device 240a. Other forms of communicating the approval/denial report from the business entity to the potential customer may additionally or alternatively be provided. It should be understood that the ordering of the steps 302-328 are illustrative and that alternative ordering may be utilized in accordance with the principles of the present invention. Moreover, it should be understood that additional and/or alternative steps may be utilized in performing the customer onboarding or other compliance process.

With regard to FIG. 4, a block diagram of illustrative modules 400 that may be executed by a computing system for performing compliance of business data in accordance with the principles of the present invention is shown. The modules 400 may include a policy engine 402, execution engine 404, content enrichment engine 406, and orchestration engine 408, and each of these engines 402-408 may operate in conjunction with one another. However, although each of the modules 400 are shown as a set, it should be understood that the policy engine 402 may operate separate from the other engines as once the assertions are grouped into decision-tables for execution, the execution engine 404, content enrichment engine 406, and orchestration engine 408 may be operated independently. Thus, a third-party provider may generate the decision-tables for execution and a business entity may execute the decision-tables on business data of potential customers, for example, as previously described.

The policy engine 402 may use ontology modeling to encode business policies as assertions in a semantic web format or web-based ontology language (OWL), such as an RDF format, where the RDF format may be an RDF triple and modeled as subject-predicate-object. The assertions may be grouped into decision-tables for execution. Each decision table is a reusable block of assertions and usage may be orchestrated by a standard business process tool. The policy model 402, thus, define data requirements and assertions for use by the execution engine 404.

The execution engine 404 may be a stateless machine that understands the assertion groups in the decision-tables. Execution is designed to enact or apply the assertions (e.g., business policies, government regulations) on business data. The business data may be unstructured, semi-structured, and structured, as previously described. The business data may be “inverted indexed” to enable advanced search and query capabilities across structured, semi-structured, and unstructured data and associated dashboards.

The content enrichment engine 406 may provide a framework from which a designed outcome of modeling policies as assertions for the policy engine is a domain-rich vocabulary that represents business semantics and is represented as an ontology model. The semantic ontology model enhances a natural language interpreter that allows for understanding business documentation that is in unstructured or semi-structured form, thereby allowing the business data to be processed by a computer as opposed to being manually entered.

The orchestration engine 408 is used to create a model-driven business process or pattern. The orchestration engine 408 allows the orchestration of decision-tables to enact a business process. That is, the ontology-model in the policy engine 402 determines the sequence in which the decision-tables are to be executed and represents the model that drives the business process (i.e., a model-driven business process). The orchestration engine 408 is executed as a state machine.

In operation, every government regulation and business rule may be modeled into the policy engine 402 as assertions using a business requirements document (BRD), and create rules for automatically “reading” documents. In creating the policy rules, the regulations may be broken down to guidelines of which the business entity should follow along with business policies that are particular to the business entity and then combined to create a complete set of policy rules. Three steps may be used in a decision model, including (i) create a decision table (TABLE 2) based on Decision Model Notation (DMN), (ii) perform XML encoding (TABLE 3) of a decision table as an assertion (subject-predicate-object), and (iii) convert the XML encoded decision table into XMI, whereby the XMI output (TABLE 4) may be sent to feed the assertions to the execution engine in the web-based ontology language (e.g., RDF triple).

TABLE 2
Decision Model Notation: Decision Table
Decision Table Determine LegalNameLabel

| If | | If | | Then | |
|---|---|---|---|---|---|
| $document.documentType | | $document.nounPhrase | | $document.legalNameLabel | |
| Document Type | | Noun Phrase | | Legal Name Label | |
| Is | Articles of Incorporation | Is | “Name of Company” | Is | NameOfCompany |
| Is | Articles of Organization | Is | “Name of Organization” | Is | NameOfOrganization |
| Is | Tax Form W-9 | Is | “Name (as shown on | Is | businessName |
| | | | your income tax return) | | |

TABLE 3
Decision Model Notation: XML Encoding

<Decision name=“DetermineLegalNameLabel”>
<Decision_Rules>
<DecisionRule name=“Rule1”>
<Condition>
<Subject>
<DMN.InformationItem
xmi.idref=“DMN-InformationItem_$document.documentType”/>
</subject>
<operator>is</operator>
<operand>
<DMN.InformationItem xmi.idref = “DMN-InformationItem_Articles
Of Incorporation”/>

TABLE 4
Decision Model Notation: XMI Export (OWL)

<InformationItem
xmi.id=“DMN-InformationItem_$document.documentType”
Name=“$document.documentType”>
<Related_Element>
<OWLBase.OWLClass href=“OWLClass-Legal Document-Document
Type”/>
</Related_Element>
<Contains_Element/>
</InformationItem>

An example of a use case for KYC customer onboarding is provided below in TABLE 5. As shown, the use case defines a portion of a requirements document that can be used for defining a model for the policy engine 402.

TABLE 5
Decision Model Notation: XMI Export (OWL)

```
 Client onboarding
  ∘ Regulation: US Patriot ACT/SECTION 326
    ▪ KYC
       CIP
        ∘ Commercial Bank
          ▪ Address
          ▪ Legal Name
          ▪ Tax ID
```

A report generator 410 may also be utilized to generate reports of policies being applied to business data in performing a compliance review. The report generator 410 may also be utilized to present listings of assertions, listings of workflow(s) and groupings of assertions at each step of the workflow(s), and so forth.

An audit records engine 412 may be configured to generate audit records. The audit records engine 412 may be a standalone engine, as shown, and/or be integrated into the execution engine 404, for example, so as to generate audit records as a government regulation compliance review is being performed. The audit records engine 412 may also record non-assertion execution information, such as revision of government regulation from which the assertions are derived, revision of the assertions, reference identifier of each business document from which the business data has been derived, operator identifier who initiates the compliance review, and so on.

With regard to FIG. 5, a flow diagram of an illustrative workflow 500 for opening new accounts to comply with the Foreign Accounts Tax Compliance Act (FATCA) for customer onboarding as defined in the policy engine workflow of FIG. 4 is shown. The workflow 500 shows how a graphical model can be created to represent a portion of customer onboarding. Assertions can be created from each of the steps in the workflow 500. From these assertions, a decision table, as shown below in TABLE 6, can be created. TABLE 6 provides assertions, sub-assertions, documents and XML field names at which the data can be obtained to answer each of the respective assertions.

TABLE 6
Example Decision Table

| UC Step Assertion | Sub-Assertion | Document | XML Field Name |
|---|---|---|---|
| Step 1 Check if valid W-8 exists | a) Check if document is correct | W-8BEN-E | docType |
| | W-8 | | |
| Step 1 Check if valid W-8 exists | i. Is document a W-8BEN-E? | W-8BEN-E | docType |
| | AND | | |
| Step 1 Check if valid W-8 exists | ii. Is EIN provided by sales same | W-8BEN-E | EIN |
| | as “EIN” on document? OR | | |
| Step 1 Check if valid W-8 exists | iii. Is Legal Name/Address | W-8BEN-E | entityStreetAddress, |
| | provided by sales same as “Full | | entityCityAddress, |
| | Legal Name”/“Address of | | entityCountryAddress |
| | Principal Business” on | | |
| | document? | | |
| Step 1 Check if valid W-8 exists | b) Check if W-8BEN-E is valid | W-8BEN-E | docType |
| Step 1 Check if valid W-8 exists | i. Is “Legal Entity Status” | W-8BEN-E | entityStatus |
| | complete? AND | | |
| Step 1 Check if valid W-8 exists | ii. Is “Notional Principal | W-8BEN-E | notionalPrincipalContracts |
| | Contracts” complete? AND | | |
| Step 1 Check if valid W-8 exists | iii. Is “FATCA Status” | W-8BEN-E | fatcaStatus |
| | complete? AND | | |
| Step 1 Check if valid W-8 exists | 1. Is “FATCA Status” = | W-8BEN-E | fatcaStatus, |
| | “Participating FFI” AND | | FFIRDCFFIConfirmation, |
| | “FFI/RDCFFI Confirmation” | | fatcaID |
| | checked AND “FATCA ID” | | |
| | filled out? OR | | |

With regard to FIG. 6, a block diagram of an illustrative content enrichment framework 600 is shown. The content enrichment framework 600 is shown to include a content enrichment engine 602 and policy engine 604 from which metadata 605 is communicated into the content enrichment engine 602. The content enrichment engine 602 may use regulatory vocabulary 608, public entity data 610, and algorithms 612 to perform natural language processing by a document enrichment engine 614 that performs XML tagging. The content enrichment engine 602 may enrich business data that is derived from customer documents 606 that may be scanned via an OCR system 616 (or electronic, PDF, or eForm documents) that creates computer readable documents 618. Output from the document enrichment engine 614 may be XML tagged business data (not shown) that is indexed, optionally inverted indexed, by an indexing engine 620. Once indexed, the business data, which is now content searchable in an unstructured format, may be stored in an XML repository for further processing by an execution engine. As understood in the art, the unstructured format, which may be considered a non-structured or NoSQL database format, as understood in the art, provides for significantly more flexibility (e.g., provides for freeform searches) than conventional structured or SQL database configurations that currently exist in business rules-based KYC compliance review systems. The NoSQL database may store the business data in a native unstructured format.

With regard to FIG. 7, an illustration of an illustrative business document 702 and business data 704 derived from the business document 702 is shown. The business document 702, which may also be considered a compliance document, is shown as a sample W-8BEN-E Form. The content enrichment framework 600 of FIG. 6 using the “policies” encoded into the policy engine 604 may convert and tag unstructured data in any user document (e.g., PDFs, TIFFs, etc.) into an XML encoded structured format, as provided in the business data 704 that is XML encoded enrichment data. The business data 704 may include both class (field) and category data (content) for use in processing and searching. Transaction data 706, including number of pages, type of document, author, creation date, version, and so forth for auditing purposes.

With regard to FIG. 8, an illustration of an illustrative execution engine environment 800 is shown. The execution engine environment 800 may include an execution engine 802 that includes a policy parser 804 configured to parse policy assertions 806 received from a policy engine 808. A business process manager (BPM) or orchestration engine 810 may communicate a process name and user provided data 812 to be executed as well as any user provided data. A content enrichment framework 814 sends business data in the form of XML documents 816 to the execution engine 802 for processing as orchestrated by the BPM 810. That is, the execution engine executes each related policy assertion against all of the data, including XML document(s) 816, user provided data 812, and data 818 from external source(s) 820 and/or internal source(s) 822 to evaluate success, partial success, or failure of the KYC customer onboarding process.

With regard to FIG. 9, a chart showing an illustrative decision table 900 inclusive of assertions 902 for a FATCA use case is shown. The decision table 900 may also include conditions 904 associated with each of the assertions 902 and descriptions 906 that are descriptions of the assertions 902. The assertions 902 may include a general assertion 908 along with sub-assertions 910 that may be grouped with the general assertion 908. In one embodiment, the sub-assertions 910 are formed in a particular hierarchical order, whereby the sub-assertions 910 are executed in the listed order. The decision table 900 may represent one of multiple decision tables (not shown) that define a workflow for performing a FATCA compliance review.

With regard to FIG. 10, a screenshot of an illustrative decision model editor 1000 that may be used in generating a decision table, in this case a FATCA compliance review is shown. The decision model editor 1000 may enable a user to enter or select a decision table name into an entry field 1002. The editor 1000 may enable a user to create or encode assertions by providing assertions 1004, column roles 1006, conditions 1008, operators 1010, and operands 1012 to be selected or defined so as to define the assertions for a decision table. In this case, assertion 1014 is defined by the data provided in the fields 1006-1012.

With regard to FIG. 11, a screenshot of an illustrative audit trail 1100 resulting from applying decision tables to business data is shown. The audit trail 1100 may display a listing of decision tasks or steps 1102 of a workflow along with results 1104 of the associated assertions 1102 that were applied to business data. The decision tasks 1102, which are formed of assertions, may be applied to the business data in an order, such as in the order shown, as established by steps of a workflow. The order of the steps of the workflow may be predetermined (e.g., established by a user in generating the workflow) or dynamically generated (e.g., semi-automatically, such as prompting a user for a next step, or automatically responsive to results of one or more previous steps). The assertions associated with each step of a workflow may be considered subsets of a set of assertions that represent government regulations (e.g., KYC) or other rules. As shown, assertion 1014 created in the decision model editor 1000 of FIG. 10 is found to have been successfully complied with by the business data to which the assertion 1014 was applied. As further shown, the assertions are listed in a hierarchical manner, where the assertions and sub-assertions (or lower level assertions) may be listed in a folder structure. Reports may similarly utilize a hierarchical manner in presenting compliance results. It should be understood that the audit trail 1100 may include additional and/or alternative information. For example, the audit trail 1100 may include a timestamp of date of execution, particular business documents and business data to which each of the assertions have been applied, and so forth.

With regard to FIG. 12, a chart showing an illustrative decision table 1200 inclusive of assertions 1202 for a KYC use case is shown. The decision table 1200 may also include conditions 1204 associated with each of the assertions 1202 and descriptions 1206 that are descriptions of the assertions 1202. The assertions 1202 may include a general assertion 1208 along with sub-assertions 1210 that may be grouped with the general assertion 1208. In one embodiment, the sub-assertions 1210 are formed in a particular hierarchical order, whereby the sub-assertions 1210 are executed in the listed order. The decision table 1200 may represent one of multiple decision tables (not shown) that define a workflow for performing a KYC compliance review.

With regard to FIG. 13, a screenshot of an illustrative decision model editor 1300 that may be used in generating a decision table, in this case a KYC compliance review is shown. The decision model editor 1300 may enable a user to enter or select a decision table name into an entry field 1302. The editor 1000 may enable a user to create or encode assertions by providing for assertions 1004, column roles 1006, conditions 1008, operators 1010, and operands 1012 to be selected or defined so as to define the assertions for a decision table. In this case, assertions 1314a-1314d (collectively 1314) were defined by the data provided in the fields 1306-1312.

With regard to FIG. 14, a screenshot of an illustrative audit trail 1400 resulting from applying decision tables to business data is shown. The audit trail 1400 may display a listing of decision tasks or steps 1402 of a workflow along with results 1404 of the associated decision tasks 1402 that were applied to business data. The decision tasks 1402, which are formed of assertions, may be applied to the business data in an order or sequence, such as in the order shown, as established by a workflow. As shown, assertions 1314a and 1314b created in the decision model editor 1300 of FIG. 13 are found to have been successfully complied with by the business data to which assertions 1314a and 1314b were applied, while assertions 1314c and 1314d were found not to have been successfully complied with by the business data to which the assertions 1314c and 1314d were applied. It should be understood that the audit trail 1100 may include additional and/or alternative information. For example, the audit trail 1100 may include a timestamp of date of execution, particular business documents and business data to which each of the assertions have been applied, and so forth.

With regard to FIG. 15, a screenshot of an illustrative user interface 1500 on which a user may perform and/or review extracted reference data of a compliance review, such as a customer onboarding compliance process, is shown. The user interface 1500 may include a number of different sections, including a search input data section 1502, assertion responses section 1504, selectable data viewing section 1506, and transaction data section 1508 that provide various information.

The search input data section 1502 may allow the user to select customer identification program (CIP) processing or Foreign Account Tax Compliance Act processing. A number of different data entry fields 1510, including legal entity name, address, city, country, EIN, entity type, and prima facie (e.g., qualified intermediary or non-qualified intermediary). It should be understood that additional and/or alternative search input data fields may be provided.

The rule responses section 1504 may include a table 1512, for example, inclusive of assertion, result, source document name, and source document date. The table is illustrative and may be scrollable and/or expandable to a full screen listing. Additional and/or alternative data fields may be provided in the table or expanded table.

The selectable data viewing section 1506 may provide the user with selectable data elements 1514 to view, including source data (e.g., operational business document(s)), reference data (e.g., data derived from the operational business document(s)), and reports (e.g., bar graph of statistical data that indicates what percent of the business data complies and does not comply with customer onboarding requirements). In response to selecting one of the selectable data elements, a table showing an associated listing of data (e.g., source data, reference data, and report(s) or selectable listing of available reports(s)) may be presented to the user in the section 1506.

The transaction data section 1508 may provide a user with a listing of underlying data used in performing the client onboarding compliance review. The transaction including number of pages, type of document, author, creation date, version, and so forth for auditing or other purposes.

With regard to FIG. 16, a screenshot of an illustrative user interface 1600 that provides a user with an audit trail of a compliance review of business data utilizing the principles of the present invention is shown. The user interface 1600 may include a number of different sections, including a search input data section 1602, assertion responses table 1604, detailed assertion execution summary table 1606, and input data or reports section 1608. Selectable graphical user elements 1610 may enable the user to selectably view (i) source data, such as a business document 1612, (ii) reference data (e.g., business data and/or metadata derived from a document), or (iii) reports generated from performing a compliance review.

The search input data section 1602 may include the same, similar, or different input fields as the search input data section 1502 of FIG. 15. Searchable audit parameters, such as timestamp of compliance review process, operator identifier, name of compliance review process, date range during which a compliance review was performed, or otherwise, may also be included to assist a user in locating audit records of a compliance review.

The assertion responses provided in the assertion responses table 1604 may include a number of compliance review parameters, such as name of assertion, result of assertion, document name(s) from which assertions are being applied, and source document date. The table 1604 also represents an audit trail of regulatory mandated documents being indexed and accumulated against assertions being executed. As an example, regulations of customer onboarding may request a “client file,” which means a list of all documents that were referenced when a regulatory compliance review was performed. Collecting the document set with corresponding assertions (i.e., regulation rules) may be provided utility the principles of the present, which prior hereto, was a very difficult and costly exercise, if at all possible. It should be understood that additional and/or alternative compliance review parameters may be utilized in accordance with the principles of the present invention. The assertion responses table 1604 may be selectable such that when a user selects an assertion data record, such assertion data record 1612, detailed assertion execution records of the assertion data record 1612 are shown in the detailed assertion execution summary table 1606. The summary table 1606 may include a listing of results and summary description of each assertion and/or sub-assertion applied to business data.

With regard to FIG. 17, a flow diagram of an illustrative process 1700 for establishing an audit trail for a government regulation compliance review is shown. The process 1700 may start at step 1702, where a set of assertions derived from government regulations may be accessed. Each of the assertions may be computer-executable and have a unique identifier associated there with. In one embodiment, the assertions may be in an RDF triple format. At step 1704, subsets of the assertions may be associated with ordered steps in a workflow. Each of the steps of the workflow may have a unique identifier associated therewith. The steps in the workflow may be predetermined or dynamically generated in response to results generated by other previous workflow steps, for example. At step 1706, the subsets of the assertions as ordered by the workflow may be applied to business data derived from at least one document. The business data may be stored in a NoSQL database, as previously described.

At step 1708, in response to applying these subsets of the assertions to the business data, unique identifiers of the steps of the workflow may be recorded in association with unique identifiers of the respective subsets of the assertions. At step 1710, the report showing which of the assertions were applied to the business data at each of the ordered steps of the workflow may be generated, thereby creating an audit trail as to which government regulations were applied to business data during the regulatory compliance review.

Additionally, compliance results data indicative of the business data complying with each respective assertion may be generated. The compliance results data may be stored in association with respective unique identifiers of the assertions. In one embodiment, compliance results data may be a Boolean value. In associating the subsets of the assertions with the steps of the workflow, sub-assertions may be associated with the assertions in at least one step of the workflow. That is, each assertion may be formed of one or more sub-assertions, which may, in the aggregate, define an assertion or determine the results of the assertion. A reference identifier may be associated with a government regulation from which the assertions were derived, and the reference identifier of the government regulation may be stored in association with the steps of the workflow, such that the reference identifier may be included in the report.

In one embodiment, a timestamp maybe generated in response to each of these subsets of assertions of the workflow be applied to the business data. The respective timestamps may be stored in associate with the unique identifiers of the steps of the workflow, and be included in the report an association with the respective steps. An identifier of a user who initiated the regulatory compliance review may be collected and stored with unique identifiers of the steps of the workflow. Furthermore, metadata may be associated with respective unique identifiers of the assertions with which the assertions were applied, and the metadata may be stored in association with their respective unique identifiers of the assertions. The metadata may also be included in the report.

It should be understood that while unique identifiers or indices associated with each of the steps of the workflow and assertions may be utilized, alternative techniques for maintaining an audit trail of assertions representative of government regulations or other policies may be utilized to provide for an audit trail in accordance with the principles of the present invention. It should further be understood that alternative processes in performing the same or similar functionality as described herein may be utilized.

The previous description is of a preferred embodiment for implementing the invention, and the scope of the invention should not necessarily be limited by this description. The scope of the present invention is instead defined by the following claims.

What is claimed:

1. A method of establishing an audit trail of a government regulation compliance review, said method comprising:
accessing, by a processing unit, a set of assertions derived from government regulations, each of the assertions being computer-executable and having a unique identifier associated therewith;
associating, by the processing unit, subsets of the assertions with ordered steps in a workflow, each of the steps in the workflow having a unique identifier associated therewith;
applying, by the processing unit, the subsets of the assertions as ordered by the workflow to business data derived from at least one document;
in response to applying the subsets of assertions to the business data, recording, by the processing unit, unique identifiers of the steps of the workflow in association with the unique identifiers of the respective subsets of the assertions; and
generating, by the processing unit, a report showing which of the assertions were applied to the business data at each of the ordered steps of the workflow, thereby creating an audit trail as to which government regulations were applied to business data during the regulatory compliance review.

2. The method according to claim 1, further comprising:
generating, by the processing unit, compliance results data indicative of the business data complying with each respective assertion; and
storing, by the processing unit, the compliance results data in association with respective unique identifiers of the assertions.

3. The method according to claim 2, wherein generating the compliance results data includes generating a Boolean value.

4. The method according to claim 1, wherein associating the subsets of assertions with the steps in the workflow includes associating sub-assertions with assertions in at least one step of the workflow.

5. The method according to claim 4, wherein generating the report includes generating a hierarchical report with expandable views of the subsets with associated results of applying the assertions.

6. The method according to claim 1, further comprising:
associating, by the processing unit, a reference identifier of a government regulation from which the assertions were derived;
storing, by the processing unit, the reference identifier in association with the steps of the workflow; and
including, by the processing unit, the reference identifier in the report.

7. The method according to claim 1, further comprising:
generating, by the processing unit, a timestamp in response to each of the subsets of assertions of the workflow being applied to the business data;
storing the respective timestamps in association with the unique identifiers of the steps of the workflow; and
including the timestamps in the report in association with the respective steps.

8. The method according to claim 1, further comprising:
collecting, by the processing unit, an identifier of a user who initiated the regulatory compliance review; and
storing, by the processing unit, the identifier of the user with the unique identifiers of the steps of the workflow.

9. The method according to claim 1, further comprising:
associating metadata with respective unique identifiers of the assertions with which the assertions were applied;
storing the metadata in association with the respective unique identifiers of the assertions; and
including the metadata in the report.

10. The method according to claim 1, wherein accessing the set of assertions includes accessing the set of assertions from a NoSQL database.

11. A system for establishing an audit trail of a government regulation compliance review, said system comprising:
a storage unit; and
a processing unit in communication with said storage unit, said processing unit being configured to:
access, from a data repository being stored on said storage unit, a set of assertions derived from government regulations, each of the assertions being computer-executable and having a unique identifier associated therewith;
associate subsets of the assertions with ordered steps in a workflow, each of the steps in the workflow having a unique identifier associated therewith;
apply the subsets of the assertions as ordered by the workflow to business data derived from at least one document;
in response to applying the subsets of assertions to the business data, recording, on said storage unit, unique identifiers of the steps of the workflow in association with the unique identifiers of the respective subsets of the assertions; and
generate a report showing which of the assertions were applied to the business data at each of the ordered steps of the workflow, thereby creating an audit trail as to which government regulations were applied to business data during the regulatory compliance review.

12. The system according to claim 11, said processing unit further being configured to:
generate compliance results data indicative of the business data complying with each respective assertion; and
store the compliance results data in association with respective unique identifiers of the assertions in said storage unit.

13. The system according to claim 12, wherein said processing unit, in generating the compliance results data, is configured to generate a Boolean value.

14. The system according to claim 11, wherein said processing unit, in associating the subsets of assertions with the steps in the workflow, is configured to associate sub-assertions with assertions in at least one step of the workflow.

15. The system according to claim 14, wherein said processing unit, in generating the report, is configured to generate a hierarchical report with expandable views of the subsets with associated results of applying the assertions.

16. The system according to claim 11, wherein said processing unit is further configured to:
associate a reference identifier of the government regulation from which the assertions were derived;
store the reference identifier in association with the steps of the workflow in said storage unit; and
include the reference identifier in the report.

17. The system according to claim 11, wherein said processing unit is further configured to:
generate a timestamp in response to each of the subsets of assertions of the workflow being applied to the business data;
store the respective timestamps in association with the unique identifiers of the steps of the workflow; and
include the timestamps in the report in association with the respective steps.

18. The system according to claim 11, wherein said processing unit is further configured to:
collect an identifier of a user who initiated the regulatory compliance review; and
store the identifier of the user with the unique identifiers of the steps of the workflow.

19. The system according to claim 11, wherein said processing unit is further configured to:
associate metadata with respective unique identifiers of the assertions with which the assertions were applied;
store the metadata in association with the respective unique identifiers of the assertions; and
include the metadata in the report.

20. The system according to claim 11, wherein said processing unit, in accessing the set of assertions, is further configured to access the set of assertions from a NoSQL database.
